(19) United States
(12) Patent Application Publication
(10) Pub. No.: US 2023/0110598 A1
(43) Pub. Date: Apr. 13, 2023

(54) MICROFLUIDIC APPARATUS

(71) Applicant: CYTESI, INC., Menlo Park, CA (US)

(72) Inventors: Tung-Yu WU, Hsinchu City (TW); Tang-Hung PO, Zhubei City (TW)

(21) Appl. No.: 17/955,853

(22) Filed: Sep. 29, 2022

Related U.S. Application Data
(60) Provisional application No. 63/253,796, filed on Oct. 8, 2021.

(51) Int. Cl. B01L 3/00

(52) U.S. Cl. CPC B01L 3/50273; B01L 3/502792; B01L 3/502715; B01L 2400/0427; B01L 2300/0645

(57) ABSTRACT

A microfluidic apparatus is provided for manipulating and sensing the droplets of fluid. The microfluidic apparatus includes an electrowetting on dielectric (EWOD) device and a sensing device. The EWOD device receives one or more droplets of fluid, and includes a plurality of electrode elements arranged in an array of rows and columns. The sensing device is disposed external or internal to the EWOD device and includes a plurality of optical sensors corresponding to the electrode elements of the EWOD device, respectively. Therefore, it is possible to reduce the cost and/or volume of the microfluidic apparatus.

### CROSS-REFERENCE TO RELATED APPLICATIONS

This application claims the benefit and priority to the U.S. Provisional Patent Application No. 63/253,796 filed on Oct. 8, 2021, the entirety of which is incorporated herein by reference.

### TECHNICAL FIELD

The present disclosure generally relates to a microfluidic apparatus. More particularly, the present disclosure relates to a microfluidic apparatus with an electrowetting-on-dielectric (EWOD) device.

### BACKGROUND

The microfluidic apparatus includes electrodes to manipulate or process droplets of fluid (e.g., moving, splitting, merging or heating the droplets) in a defined space. The microfluidic apparatus may utilize an electrowetting on dielectric (EWOD) principle: specifically, as shown in FIGS. 1A and 1B, when a droplet 91 of fluid is present on one of the electrodes 92 and an electrical potential is applied to that electrode 92, it is possible to change the wetting of the solid-liquid interface at the position corresponding to that electrode 92, and the contact angle θ on the interface between the droplet 91 and the electrode 92 is changed accordingly; if there is a potential difference between the electrode 91 and the droplet 92 to result in a different contact angle θ, a lateral pushing force will be generated, thereby causing the droplet 91 to move laterally on the electrode substrate 93.

During the manipulation of droplets, the droplets may fail to move along the specified path, due to the volume of the droplets being too large, or the droplets carrying impurities, or no electrical potential being applied to the electrode for example. Thus, the positions of the droplets need to be sensed or observed constantly or frequently for ensuring the desired manipulation of the droplet in the microfluidic apparatus.

Conventionally, the droplets of fluids in the microfluidic apparatus are sensed or observed by a high-resolution camera fixed on or above the microfluidic apparatus, and such camera is typically expensive and large in physical size. Accordingly, the performances and scopes of applications of the microfluidic apparatus are limited, especially for the “Lab on a Chip (LoC)” applications, as the high-resolution camera is not portable.

Therefore, the conventional configurations have not adequately addressed issues associated with the optical sensing of droplets in the EWOD-based microfluidic apparatus.

### SUMMARY OF INVENTION

According to embodiments of the present disclosure, there is provided an optical sensing of droplets in an EWOD (or AM-EWOD) device or other microfluidic device within a general microfluidic apparatus, without using an expensive or huge image-capturing device (e.g., camera), so as to reduce the cost and volume of the microfluidic apparatus. Thus, the microfluidic apparatus may facilitate the development of LoC application/system.

In an embodiment of the present disclosure, the microfluidic apparatus comprises: an electrowetting on dielectric (EWOD) device, configured to receive one or more droplets of fluid, the EWOD device comprising a plurality of electrode elements arranged in an array of rows and columns; and a sensing device, disposed external or internal to the EWOD device and comprising a plurality of optical sensors corresponding to the electrode elements of the EWOD device, respectively.

In an embodiment of the present disclosure, the sensing device is disposed above the EWOD device.

In an embodiment of the present disclosure, the sensing device is disposed under the EWOD device.

In an embodiment of the present disclosure, the sensing device is disposed in the EWOD device.

In an embodiment of the present disclosure, each of the optical sensors of the sensing device comprises a charge-coupled device or a CMOS device.

In an embodiment of the present disclosure, the optical sensors of the sensing device form a large-area sensor.

In an embodiment of the present disclosure, each of the optical sensors of the sensing device is an in-cell or under-cell optical sensor, or an independent optical sensor.

In an embodiment of the present disclosure, the apparatus further comprises a light source disposed under or above the EWOD device.

In an embodiment of the present disclosure, the light source comprises an OLED layer.

In an embodiment of the present disclosure, each of the electrode elements comprises an electrode, a TFT layer coupled to the electrode and a dielectric layer covering the electrode and the TFT layer.

In an embodiment of the present disclosure, each of the electrode elements further comprises a hydrophobic layer covering the dielectric layer.

In an embodiment of the present disclosure, the electrode is an ITO electrode.

In an embodiment of the present disclosure, the optical sensor is embedded with the TFT layer.

In an embodiment of the present disclosure, the optical sensor is embedded with a TFT substrate under the TFT layer.

In an embodiment of the present disclosure, each of the columns includes a column addressing line that provides a control signal to a corresponding column of the electrode elements, and each of the rows includes a row addressing line that provides a control signal to a corresponding row of the electrode elements.

Based on the embodiments of the present disclosure, compared with the conventional image-capturing device, the sensing device used in this microfluidic apparatus has much smaller physical size, so it is convenient to carry or be integrated with the EWOD device; besides, the sensing device may reduce the cost of the microfluidic apparatus. Moreover, the optical sensors of the sensing device may sense the droplet on the individual electrode elements of the EWOD device, so as to easily detect the movement of the droplet. The light source may emit lights to the individual electrode elements, dimming some of the electrode elements without affecting the electrode elements that need to be bright, thereby facilitating the sensing of the droplet.

Further features of the present disclosure will become apparent from the following description of exemplary embodiments (with reference to the attached drawings).

### BRIEF DESCRIPTION OF DRAWINGS

FIGS. 1A and 1B are schematic views illustrating the principle of electrowetting on dielectric (EWOD);

FIG. 2A is a top view illustrating the configuration of the microfluidic apparatus in accordance with a first embodiment of the present disclosure;

FIG. 2B is a side view illustrating the configuration of the microfluidic apparatus of FIG. 2A;

FIG. 3 is a view illustrating the circuit diagram of the microfluidic apparatus of FIG. 2A;

FIG. 4A is a top view illustrating the configuration of the electrode element in the microfluidic apparatus of FIG. 2A;

FIG. 4B is a sectional view illustrating a part of the electrode element in the microfluidic apparatus of FIG. 4A;

FIG. 4C is a sectional view illustrating another part of the electrode element in the microfluidic apparatus of FIG. 4A;

FIG. 5 is another sectional view illustrating the parts of the electrode element in the microfluidic apparatus of FIG. 4A;

FIG. 6 is a schematic view illustrating the circuit diagram of the electrode element in the microfluidic apparatus of FIG. 2A;

FIG. 7 is a side view illustrating the configuration of the microfluidic apparatus in accordance with a second embodiment of the present disclosure;

FIGS. 8A and 8B are exploded and top views illustrating the configuration of the microfluidic apparatus in accordance with a third embodiment of the present disclosure;

FIG. 8C is an exploded view illustrating the configuration of the microfluidic apparatus in accordance with a fourth embodiment of the present disclosure;

FIG. 9 is a schematic view illustrating the images formed by the sensing device in microfluidic apparatus in accordance with one of the embodiments of the present disclosure;

FIG. 10 is a top view illustrating the configuration of the microfluidic apparatus with another sensing device in accordance with one of the embodiments of the present disclosure;

FIGS. 11A and 11B are side views illustrating the configuration of the microfluidic apparatus with another sensing device in accordance with one of the embodiments of the present disclosure; and

FIG. 12A is a side view illustrating the configuration of the microfluidic apparatus in accordance with a fifth embodiment of the present disclosure.

FIG. 12B is a side view illustrating the configuration of the microfluidic apparatus in accordance with a sixth embodiment of the present disclosure.

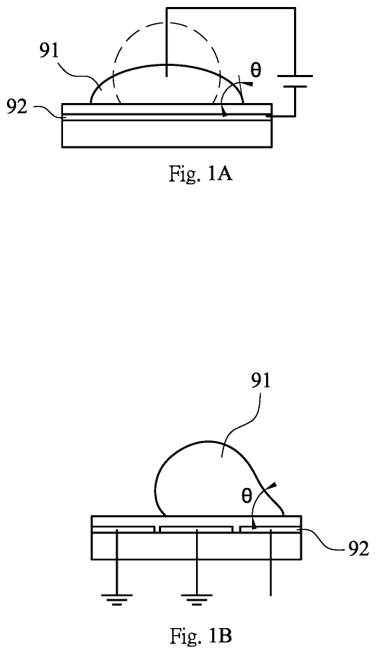

### DETAILED DESCRIPTION

In the following description, numerous specific details are set forth to provide a thorough understanding of embodiments of the present disclosure. It will be apparent to person having ordinary skill in the art that the embodiments of the present disclosure may be practiced without those specific details. In other instances, well-known features, such as thin-film transistor (TFT), electrowetting-on-dielectric (EWOD), circuit design layouts, may be not described in detail so as to not unnecessarily obscure the embodiments of the present disclosure. Moreover, multiple features are described in the embodiments, but no limitation is made to an invention that requires all such technical features, and such technical features may be combined or replaced as appropriate. Furthermore, in the attached drawings, the same reference numerals are given to the same or similar components, and redundant description thereof may be omitted. It is to be appreciated that the components shown in the attached drawings may not necessarily be drawn to scale.

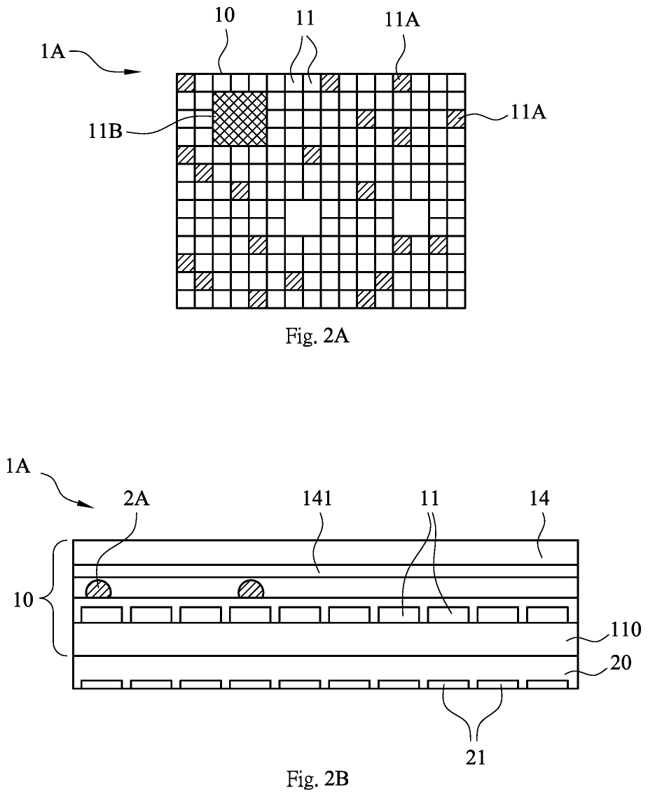

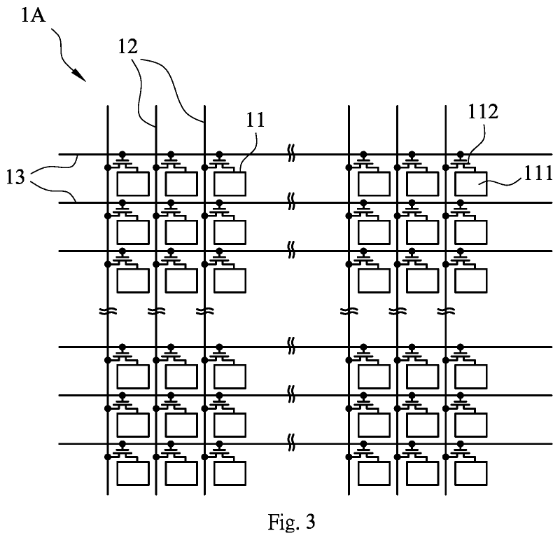

Please refer to FIG. 2A, FIG. 2B and FIG. 3, according to a first embodiment of the present disclosure, a microfluidic apparatus 1A is disclosed. The microfluidic apparatus 1A may comprise an electrowetting-on-dielectric (EWOD) device 10 for receiving one or more droplets 2A of fluids, and a sensing device 20 disposed external or internal to the EWOD device 10 for sensing the droplets 2A of fluids (capturing the image of the droplets) in the EWOD device 10.

The EWOD device 10 may be an active matrix EWOD (AM-EWOD) device 10 that comprises a plurality of electrode elements 11 implemented in an active matrix array. That is, the electrode elements 11 are arranged in an array of rows and columns to form a matrix array. The droplets 2A may be moved from one of electrode elements 11 to the adjacent ones along the same row or column.

Each of the electrode elements 11 in the matrix array may be referred to as one basic pixel 11A to move a small droplet 2A. The adjacent basic pixels (i.e., cluster of pixels) 11A may form one large pixel 11B, for example, 1×2, 2×2 or 3×3 basic pixels 11A to form one large pixel 11B, so as to manipulate a large droplet 2A or manipulate several small droplets 2A together.

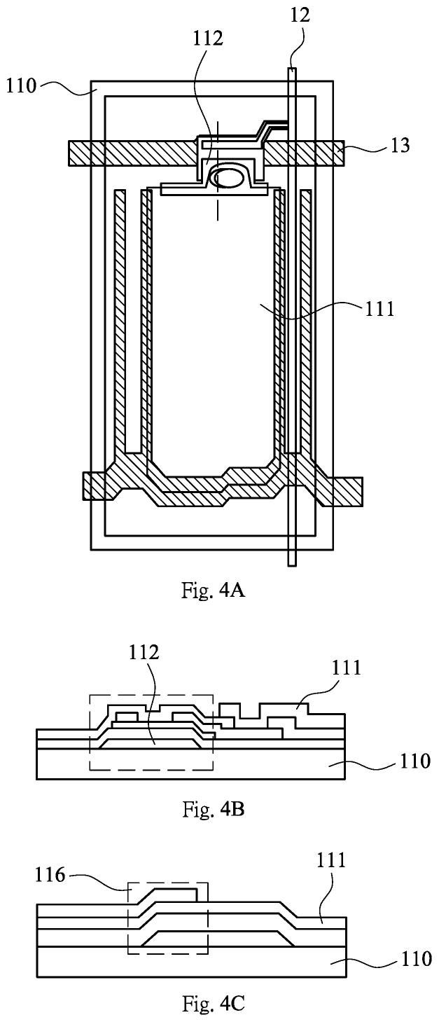

More specifically, as shown in FIGS. 4A to 4C, each of the columns includes a column addressing line 12 electrically connected to the electrode elements 11 along the corresponding column, so as to provide a control signal to the corresponding column of the electrode elements 11; each of the rows includes a row addressing line 13 electrically connected to the electrode elements 11 along the corresponding row, so as to provide a control signal to the corresponding row of the electrode elements 11. Each of the electrode elements 11 may comprise an electrode 111 and a thin-film transistor (TFT) 112, or other suitable transistor or switch, coupled to the electrode 111. The gate of the TFT 112 may be connected to the column addressing line 12, the drain of the TFT 112 may be connected to the row addressing line 13 and the source of the TFT 112 may be connected to the electrode 111. It is noted that the electrode elements 11, the column addressing lines 12 and the row addressing lines 13 may be formed on the same substrate 110, and the TFTs 112 of the electrode elements 11 as a whole may be referred to as a TFT layer 112.

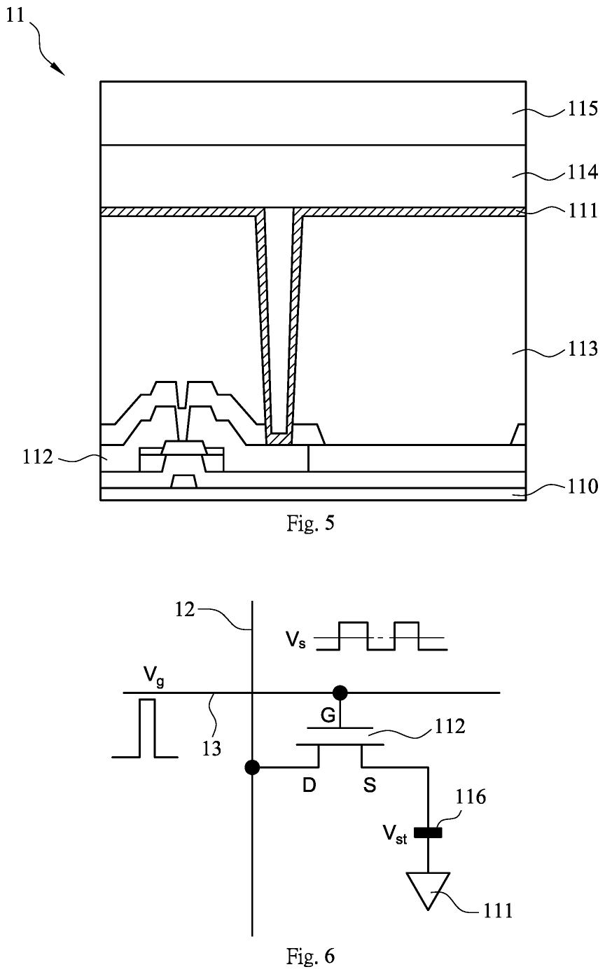

Please refer to FIG. 5, each of the electrode elements 11 may further comprise a planarization layer 113, a dielectric layer 114 and a hydrophobic layer 115. The planarization layer 113 is formed on and covers the TFT (i.e., TFT layer) 112, thereby providing a planar top surface; the planarization layer 113 may be made of organic material. The electrode 111 is formed on the planarization layer 113 and extended through the planarization layer 113 to couple to the TFT 112; the electrode 111 may be made of indium tin oxide (ITO), or other suitable material, so the electrode 111 may be referred to as an ITO electrode. Besides, the thickness of the electrode 111 may be around 750 Å, and the thickness of the planarization layer 113 may be not greater than 2 μm; the length/width of the electrode 111 may be 100 μm, and the interval between two adjacent electrodes 111 may be 5 μm; the size/dimension may be varied according to the practical application, such as the diameter of the droplet 2A of fluid.

The dielectric layer 114 is formed on the planarization layer 113 (i.e., on the top surface of the planarization layer 113) to cover the electrode 111 and the TFT 112, and the hydrophobic layer 115 is formed on the dielectric layer 114 (i.e., on the top surface of the dielectric layer 114) to cover the dielectric layer 114. As the planarization layer 113 provides a planar top surface, the dielectric layer 114 and hydrophobic layer 115 may have uniform thickness to facilitate the manipulation of droplet 2A of fluid. The dielectric layer 114 may be made of SiNx or Al₂O₃, and the hydrophobic layer 115 may be made by CYTOP (amorphous fluoropolymer with optical transparency), CyteSi material, or other suitable materials.

It is noted that the planarization layers 113 in the respective electrode elements 11 may be integrally formed, the dielectric layers 114 in the respective electrode elements 11 may be integrally formed, and the hydrophobic layers 115 in the respective electrode elements 11 may be formed integrally as well.

Moreover, as illustrated in FIGS. 4B and 4C to maintain a constant voltage on the charged electrode 111 over entire manipulation, each of the electrode elements 11 may further comprise a capacitor 116 connected to the electrode 111, and the capacitor 116 may be partly overlaid with the electrode 111.

Please refer to FIGS. 3 and 6, which illustrate the equivalent circuit of the EWOD device 10 and the electrode element 11 respectively, when control signals (V_{g}) are transmitted to the third column addressing line 12 and the second row addressing line 13 to turn on the TFT 112 of the corresponding electrode element 11 for example, the electrical potential voltages (Vₛ) will be applied to the electrode 111 in the corresponding electrode element 11 to move the droplet 2A on or above the electrode 111.

Please refer back to FIGS. 2A and 2B, the technical contents of the EWOD device 10 are described as above, and the technical contents of the sensing device 20 will be described. The sensing device 20 in this embodiment is disposed external to the EWOD device 10, in which the sensing device 20 may be disposed under the EWOD device 10, i.e., under the substrate 110 of the EWOD device 10. The sensing device 20 comprises a plurality of optical sensors (i.e., image or photo sensors) 21 corresponding to the respective electrode elements 11 of the EWOD device 10, and thus the optical sensors 21 are also arranged in an array of rows and columns similar or identical to the array of the electrode elements 11. As the electrode 111, the planarization layer 113, the dielectric layer 114 and the hydrophobic layer 115 in the electrode element 11 are transparent to some extent, the droplet 2A above may be sensed by the optical sensor 21. The sizes (length/width) of the optical sensor 21 may be larger than or identical to the sizes of the electrode 111 in the corresponding electrode element 11, so that the optical sensor 21 may capture the image among the whole electrode 111; alternatively, the sizes of the optical sensor 21 may be smaller than the sizes of the electrode 111.

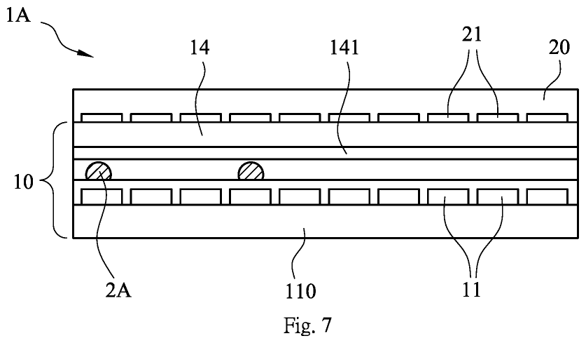

Please refer to FIG. 7, according to a second embodiment of the present disclosure, the sensing device 20 may be disposed above the EWOD device 10. That is, the sensing device 20 is disposed above a top (common) substrate 14 with a common electrode 141 of the EWOD device 10 which is transparent to some extent, and the sensing device 20 may capture the image of the droplet 2A on the electrode element 11 through the top electrode plate 14.

It is noted that the sensing device 20 may be detachable from the EWOD device 10, so as to maintain the sensing device 20 or replace the sensing device 20 with another one that is sensitive to different range of wavelengths (e.g., infrared light).

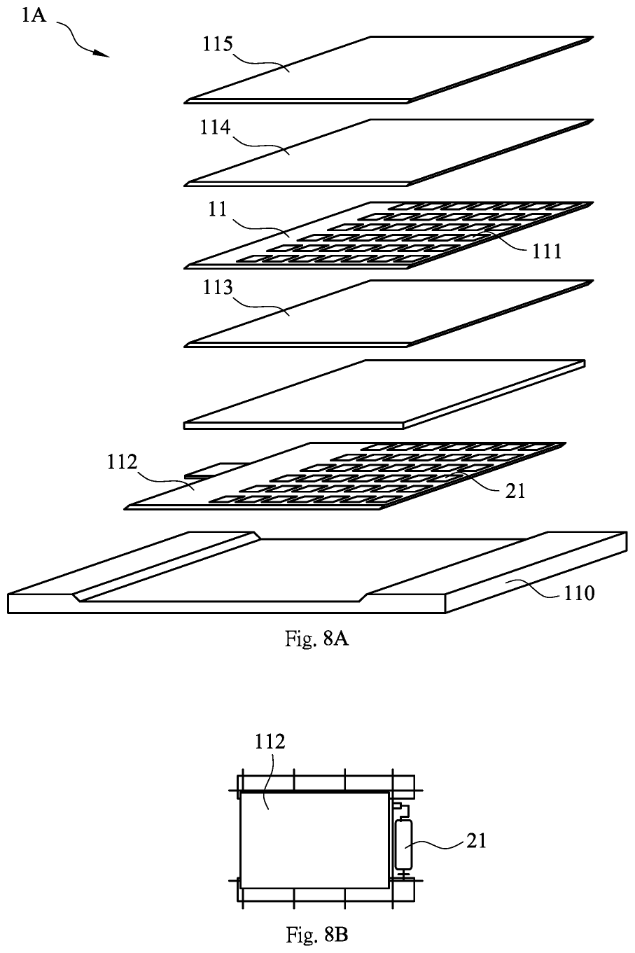

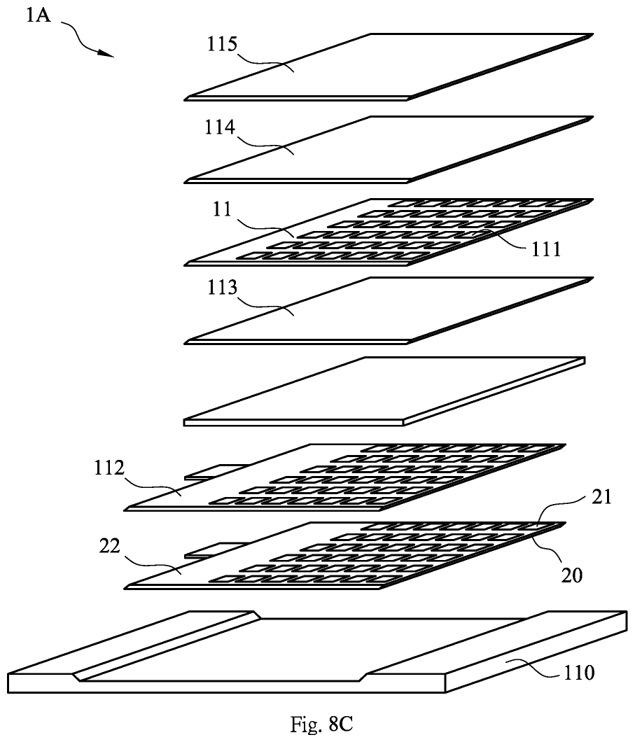

Please refer to FIGS. 8A to 8C, according to third and fourth embodiments of the present disclosure, the sensing device 20 may be disposed internal to the EWOD device 10, in which the sensing device 20 is formed in the EWOD device 10. That is, the optical sensor 21 of the sensing device 20 may be formed on the substrate 110 below the electrode 111 in the electrode element 11; more specifically, the optical sensor 21 may be an in-cell optical sensor that is embedded with the TFT layer 112 (on the same layer) as shown in FIGS. 8A and 8B, or the optical sensor 21 may be an under-cell optical sensor that is embedded on a TFT substrate 22 of the sensing device 20 under the TFT layer 112, as shown in FIG. 8C. The optical sensor 21 may be controlled by the TFT 112 in the corresponding electrode element 11, or controlled by the TFT substrate 22, so that the optical sensor 21 may be actuated when the corresponding electrode element 11 moves the droplet 2A thereon. The other optical sensors 21 corresponding to the electrode elements 11 with no droplets thereon may be disabled to lower power consumption.

It is noted that all of the optical sensors 21 in the sensing device 20 may be normally actuated during the manipulation of droplets 2A by the EWOD device 10, so that no individual controlling or switching is needed for the optical sensors 21.

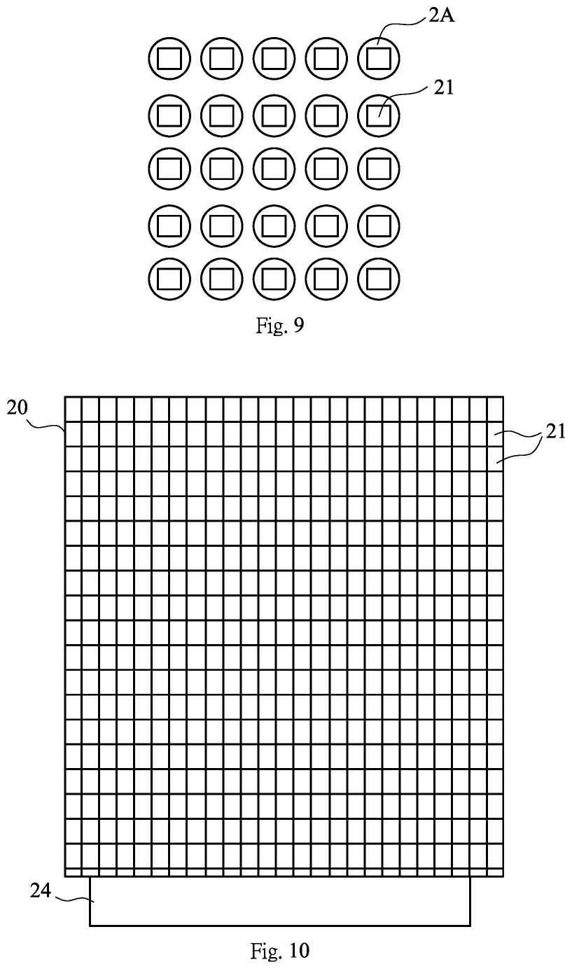

Each of the optical sensors 21 may comprise a charge-coupled device (CCD), a CMOS device or other suitable device/component that may record and convey the information of lights into electrical signals to form image. The optical sensors 21 may function as a two-dimensional (2D) camera array, such as an under-panel fingerprint camera commonly used in the smartphone. As shown in FIG. 9, the images generated by the optical sensors 21 may be collectively shown as an array on a display electrically connected to the sensing device.

Please refer to FIG. 10, in an alternative embodiment, the sensing device 20 may be configured such that the optical sensors 21 form a large-area sensor. The large-area sensor may be made by deposition of printed optical sensors 21 on a flexible substrate, or by stitching the optical sensors 21.

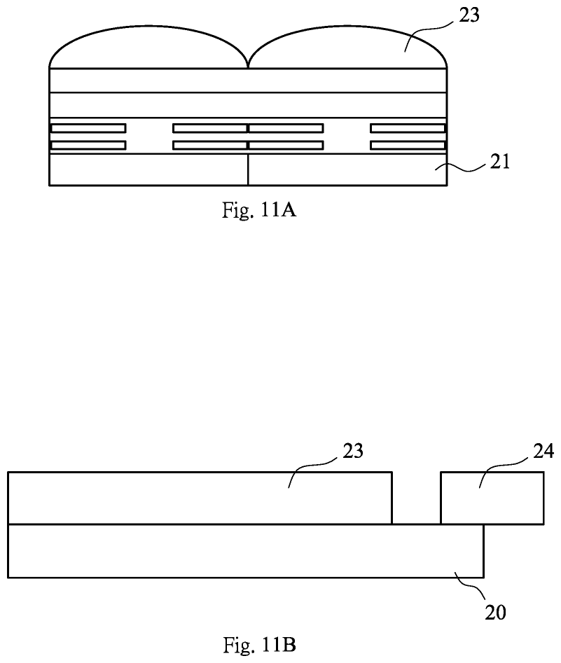

Please refer to FIGS. 11A and 11B, the sensing device 20 in the above embodiments may further comprise an optical engine 23 (e.g., micro-lens, filter or collimator) above or directly on the optical sensors 21, i.e., between the optical sensor 21 and the electrode elements 11 of the EWOD device 10, so as to collect and/or modify the lights from the droplets 2A on the electrode elements 11 to the optical sensors 21. The sensing device 20 may further comprise a readout integrated circuit (IC) 24 electrically connected to the optical sensors 21 for collecting the electrical signal from each of the optical sensors 21 and transferring the electrical signals to the output taps for readout.

Via the above embodiments, the microfluidic apparatus 1A utilizes the sensing device 20 which is relatively small and portable and is not expensive to some extent, instead of an expensive or huge camera, so that it is possible to reduce the cost and volume of the microfluidic apparatus 1A, thereby facilitating the development of LoC application/system.

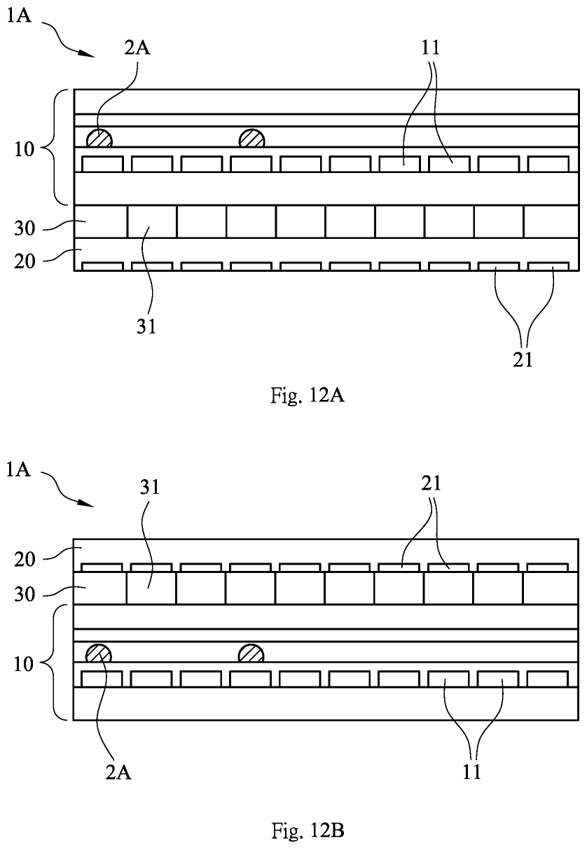

Please now refer to FIGS. 12A and 12B, according to fifth and sixth embodiments of the present disclosure, the microfluidic apparatus 1A may further comprise a light source (lighting system) 30 which is disposed above or under the EWOD device 10 to provide lights onto the electrode elements 11, as well as the droplets 2A on the electrode elements 11. The light source 30 may also be disposed between the EWOD device 10 and the sensing device 20 if desired. The light source 30 may include an OLED layer 31, with is capable of pixel dimming for emitting lights to just some of electrode elements 11 with droplets 2A, thereby facilitating the sensing of the droplets 2A or saving of power consumption. Alternatively, the light source 30 may include an LED layer (mini-LED layer) 31 that may emit lights to individual electrode elements 11 as well.

The lights from the light source 30 may be visible or invisible lights that embody specific wavelength in accordance with the droplets 2A, so as to excite a target constituent within the droplet 2A. The light source 30 may simply provide lights to ease the sensing/observation of the droplets 2A through the sensing device 20, with no intention/need to excite the target constituent or change the property of droplet 2A. It is noted that the light source 30 may be detachable from the EWOD device 10, so as to service the light source 30 or replace the light source 30 with another one that can emit lights with different range of wavelengths.

The microfluidic apparatus 1A with the built-in light source 30 further facilitates the development of LoC application/system, as there is no need to set up an external light source which might be large in physical size and obscure the observation of the droplet 2A.

It should be understood by those skilled in the art that various modifications, combinations, sub-combinations and alterations may occur depending on design requirements and other factors insofar as they are within the scope of the accompanying claims or the equivalents thereof.

1. A microfluidic apparatus comprising:
an electrowetting on dielectric (EWOD) device, configured to receive one or more droplets, the EWOD device comprising a plurality of electrode elements arranged in an array of rows and columns; and
a sensing device, disposed external to the EWOD device and comprising a plurality of optical sensors corresponding to the electrode elements of the EWOD device, respectively.

2. The microfluidic apparatus according to claim 1, wherein the sensing device is disposed above or under the EWOD device.

3. The microfluidic apparatus according to claim 1, wherein each of the optical sensors of the sensing device comprises a charge-coupled device or a CMOS device.

4. The microfluidic apparatus according to claim 1, wherein the optical sensors of the sensing device form a large-area sensor.

5. The microfluidic apparatus according to claim 1, wherein each of the optical sensors of the sensing device is an independent optical sensor.

6. The microfluidic apparatus according to claim 1, further comprising a light source disposed under or above the EWOD device.

7. The microfluidic apparatus according to claim 6, wherein the light source comprises an OLED layer.

8. The microfluidic apparatus according to claim 1, wherein each of the electrode elements comprises an electrode, a TFT layer coupled to the electrode, a dielectric layer covering the electrode and the TFT layer and a hydrophobic layer covering the dielectric layer.

9. The microfluidic apparatus according to claim 8, wherein the optical sensor is embedded with the TFT layer or is embedded with a TFT substrate under the TFT layer.

10. A microfluidic apparatus comprising:
an electrowetting on dielectric (EWOD) device, configured to receive one or more droplets, the EWOD device comprising a plurality of electrode elements arranged in an array of rows and columns; and
a sensing device, disposed internal to the EWOD device and comprising a plurality of optical sensors corresponding to the electrode elements of the EWOD device, respectively.

11. The microfluidic apparatus according to claim 10, wherein the sensing device is disposed in the electrode elements of the EWOD device.

12. The microfluidic apparatus according to claim 10, wherein each of the optical sensors of the sensing device comprises a charge-coupled device or a CMOS device.

13. The microfluidic apparatus according to claim 10, wherein the optical sensors of the sensing device form a large-area sensor.

14. The microfluidic apparatus according to claim 10, wherein each of the optical sensors of the sensing device is an in-cell or under-cell optical sensor.

15. The microfluidic apparatus according to claim 10, further comprising a light source disposed under or above the EWOD device.

16. The microfluidic apparatus according to claim 15, wherein the light source comprises an OLED layer.

17. The microfluidic apparatus according to claim 10, wherein each of the electrode elements comprises an electrode, a TFT layer coupled to the electrode, a dielectric layer covering the electrode and the TFT layer and a hydrophobic layer covering the dielectric layer.

18. The microfluidic apparatus according to claim 17, wherein the optical sensor is embedded with the TFT layer or is embedded with a TFT substrate under the TFT layer.

19. A sensing device for a microfluidic apparatus, the microfluidic apparatus comprising an electrowetting on dielectric (EWOD) device with a plurality of electrode elements, and the sensing device comprising a plurality of optical sensors which are arranged in an array of rows and columns and correspond the electrode elements of the EWOD device, respectively, wherein each of the optical sensors is configured to capture an image of a droplet on one of the electrode elements of the EWOD device.

20. The sensing device according to claim 19, wherein the optical sensors each comprise a charge-coupled device or a CMOS device, or the optical sensors form a large-area sensor.
